(19) United States
(12) Patent Application Publication
(10) Pub. No.: US 2008/0106494 A1
(43) Pub. Date: May 8, 2008

(54) Plasma display device with partly rigid and partly flexible connection between the display panel and the circuit board

(76) Inventor: Moo-il Chung, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/701,219

(22) Filed: Jan. 31, 2007

(30) Foreign Application Priority Data
Nov. 8, 2006 (KR) 10-2006-0109960

(51) Int. Cl. G09G 3/28

(52) U.S. Cl. 345/60

(57) ABSTRACT

A plasma display device having improved connection reliability between display electrodes of a plasma display panel and printed circuit boards, thereby reducing electromagnetic interference (EMI) noise, and reducing cost due to reduction of the number of components is disclosed. The plasma display device includes a partly rigid and partly flexible printed circuit board which is mounted on the chassis base and is connected to display electrodes of the plasma display panel.

### CROSS-REFERENCE TO RELATED APPLICATIONS

This application claims priority to and the benefit of Korean Patent Application No. 10-2006-0109960 filed in the Korean Intellectual Property Office on Nov. 8, 2006, the entire contents of which are incorporated herein by reference.

### BACKGROUND OF THE INVENTION

1. Field of the Invention

The present invention relates to a plasma display device, and more particularly, to a plasma display device capable of improving connection reliability between display electrodes of a plasma display panel and a partly rigid and partly flexible printed circuit board by connecting the partly rigid and partly flexible printed circuit board to the display electrodes, thereby reducing electromagnetic interference (EMI) noise, and reducing cost due to reduction of the number of components.

2. Description of the Related Technology

Generally, a plasma display device includes a plasma display panel for displaying an image, a chassis base which is fixed to the plasma display panel to support the plasma display panel, and a plurality of printed circuit boards which are mounted on the chassis base and electrically connected to the plasma display panel.

The plasma display panel generates plasma through gas discharge and excites a phosphors by using vacuum ultra-violet (VUV) radiation emitted from the plasma, thereby displaying an image by using visible light of red (R), green (G), and/or blue (B) obtained by stabilizing the excited phosphors.

Since the plasma display panel seals two facing glass substrates including address electrodes and display electrodes which cross each other corresponding to discharge cells, the plasma display panel has weak mechanical rigidity with respect to an external impact. Accordingly, the chassis base is made of metal of which mechanical strength is greater than that of the glass substrates to support the plasma display panel.

The chassis base has functions of supplying a space for mounting the printed circuit boards, dissipating heat of the plasma display panel, and grounding electromagnetic interference (EMI), in addition to the function of supplying the mechanical rigidity for supporting the plasma display panel.

Moreover, in order to perform the aforementioned functions, the plasma display panel is fixed to a front surface of the chassis base by interposing a double sided tape therebetween. The printed circuit boards are mounted on a rear surface of the chassis base.

A plurality of bosses are formed on the rear surface of the chassis base, the printed circuit boards are disposed on the bosses, and set screws are engaged to the bosses through the printed circuit boards. Accordingly, the printed circuit boards are mounted on the chassis base.

The plasma display device includes the plurality of printed circuit boards in order to perform functions for driving the plasma display panel. Specifically, the printed circuit boards include a sustain board for controlling sustain electrodes, a scan board for controlling scan electrodes, and an address buffer board for controlling address electrodes.

Display electrodes of the plasma display panel include the sustain electrodes and the scan electrodes. The sustain electrodes are supplied with a common sustain voltage. However, the scan electrodes are each supplied with scan voltages, respectively. The scan voltages are generated in the scan integrated circuit (IC) and sequentially applied to the scan electrodes. Accordingly, the scan board includes a separate scan buffer board. The scan buffer board includes the scan IC.

In addition, the printed circuit boards include an image processing/control board which receives image signals from the outside of the plasma display device and generates control signals for driving the address electrodes and control signals for driving the sustain and scan electrodes to apply the control signals to the corresponding boards. The printed circuit boards include a power board for supplying power needed for driving the aforementioned boards.

The sustain board is connected to the sustain electrodes, which are drawn out from the inside of the plasma display panel, through a flexible printed circuit (FPC) and a connector. The scan board is connected to the scan electrodes, which are drawn out from the inside of the plasma display panel, through an FPC and a connector. The scan board is connected to the scan buffer board through an FPC and a connector, or through a cable and a connector.

In the plasma display device, engaging defects between connectors may be caused by dusts or impurities. Accordingly, it is difficult to secure connection reliability between the plasma display panel and the sustain and scan boards and between the scan board and the scan buffer board. EMI noise may occur, and cost increases due to increase of the number of components.

### SUMMARY OF CERTAIN INVENTIVE ASPECTS

The present invention provides a plasma display device capable of improving connection reliability between display electrodes of a plasma display panel and a partly rigid and partly flexible printed circuit board by connecting the partly rigid and partly flexible printed circuit board to the display electrodes, reducing electromagnetic interference (EMI) noise, and reducing cost due to reduction of the number of components.

One aspect is a plasma display device including a plasma display panel configured to display an image and having display electrodes, a chassis base configured to support the plasma display panel, and a partly rigid and partly flexible printed circuit board mounted on the chassis base on a side opposite the plasma display panel and connected to the display electrodes of the plasma display panel.

Another aspect is a plasma display device including a plasma display panel configured to display an image, a chassis base configured to support the plasma display panel, and a printed circuit board mounted on the chassis base and connected to display electrodes of the plasma display panel with a flexible circuit.

### BRIEF DESCRIPTION OF THE DRAWINGS

The above and other features and advantages will become more apparent by describing in detail embodiments with reference to the attached drawings in which:

FIG. 1 is a perspective view schematically illustrating a plasma display device by exploding the plasma display device according to an embodiment;

FIG. 2 is a top plan view illustrating a connection state between a partly rigid and partly flexible printed circuit board and display electrodes of a plasma display panel viewed from a rear surface direction of the plasma display panel;

FIG. 3 is a cross sectional view of the printed circuit board taken along line III-III of FIG. 2;

FIG. 4 is a perspective view illustrating a partly rigid and partly flexible printed circuit board;

FIG. 5 is a perspective view illustrating a rigid circuit board and a flexible circuit board by exploding the partly rigid and partly flexible printed circuit in FIG. 4;

FIG. 6 is a cross sectional view of the printed circuit board taken along line IV-IV of FIG. 5; and

FIG. 7 is a cross sectional view of the printed circuit board taken along line VII-VII of FIG. 5.

### DETAILED DESCRIPTION OF CERTAIN INVENTIVE EMBODIMENTS

Certain embodiments will now be described more fully hereinafter with reference to the accompanying drawings. As those skilled in the art would realize, the described embodiments may be modified in various different ways, without departing from the spirit or scope of the present invention.

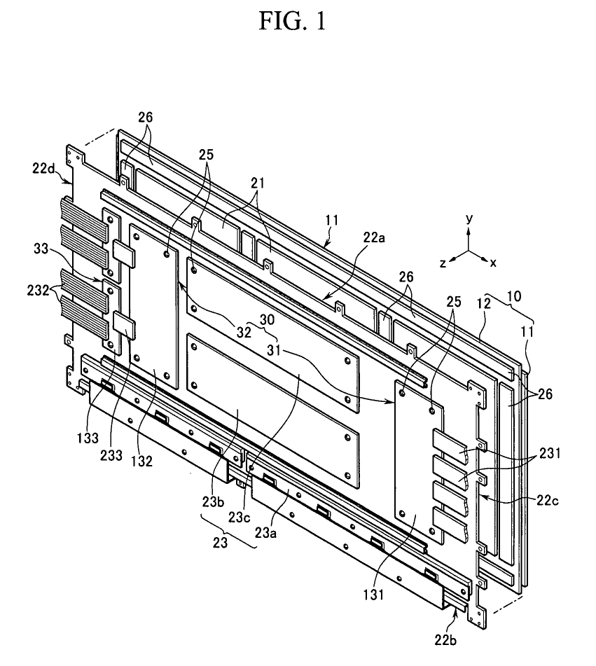

FIG. 1 is an exploded perspective view schematically illustrating a plasma display device. Referring to FIG. 1, the plasma display device includes a plasma display panel 10 for displaying an image using gas discharge, heat dissipating sheets 21, a chassis base 22, printed circuit boards 23, and partly rigid and partly flexible printed circuit boards 30.

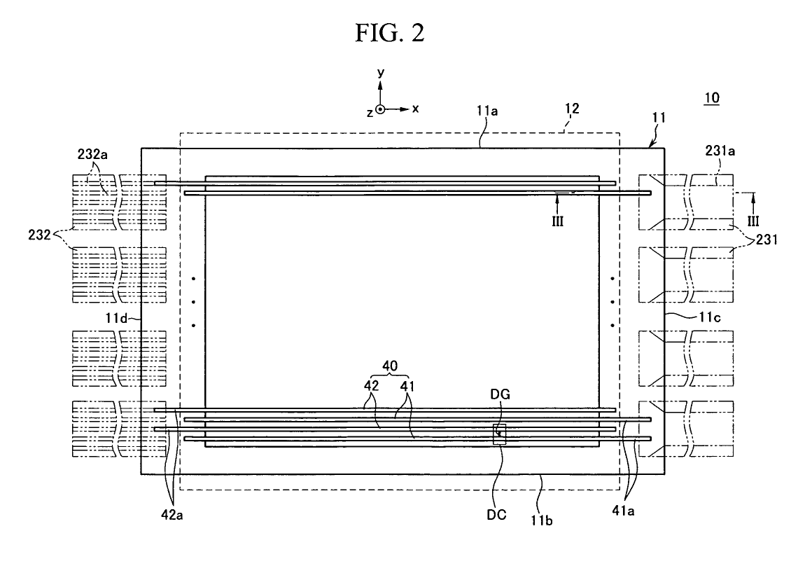

The plasma display panel 10 is formed by sealing two substrates, for example, a front substrate 11 and a rear substrate 12 which are spaced apart from each other by a certain distance. Referring to FIG. 2, the plasma display panel 10 has a generally rectangular shape with two facing long sides and two facing short sides substantially perpendicular to the long sides in the xy-plane. The rear substrate 12 is illustrated by using a dotted line. The front substrate 11 includes two long sides 11a and 11b and two short sides 11c and 11d respectively perpendicular to the long sides 11a and 11b.

For example, the plasma display panel 10 includes display electrodes 40 and address electrodes (not shown) which cross each other for gas discharge. Discharge cells DC are disposed at locations where the display electrodes 40 cross the address electrodes. The display electrodes 40 include sustain electrodes 41 and scan electrodes 42 which face each other in the discharge cell DC. Discharge gaps DGs are formed between the sustain electrodes 41 and the scan electrodes 42.

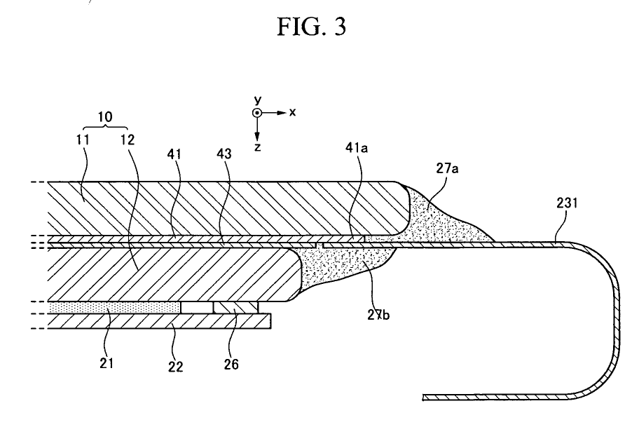

Referring to FIG. 3, the display electrodes 40 are disposed between the front substrate 11 and the rear substrate 12 in the xz-plane. More specifically, the display electrodes 40 are formed on inner surface of the front substrate 11 and covered with a dielectric layer 43. For convenience, in FIG. 3, some components, such as the discharge cells DC and the address electrodes are omitted.

The sustain electrodes 41 and the scan electrodes 42 extend in the x-axis direction in parallel with the long sides 11a and 11b of the front substrate 11. The sustain electrodes 41 and the scan electrodes 42 form discharge gap DGs therebetween along the y-axis direction. The sustain electrodes 41 are drawn out toward one short side 11c of the short sides 11c and 11d to be connected to terminals 41a formed on an end of the front substrate 11. The scan electrodes 42 are drawn out toward the other short side I Id to be connected to terminals 42a formed on an end of the front substrate 11.

Referring to FIGS. 1 and 3, again, the heat dissipating sheets 21 are included on the rear substrate 12 of the plasma display panel 10. Accordingly, heat generated in the plasma display panel 10 due to gas discharge is conducted and diffused in the xy-plane direction. In order to conduct and diffuse the heat generated in the plasma display panel 10, the heat dissipating sheets 21 may be made of, for example, an acrylic heat dissipating material, a graphite heat dissipating material, a metallic heat dissipating material, or a carbon nano tube heat dissipating material. Other materials may also be used. In FIG. 3, although the heat dissipating sheet 21 is illustrated to be adhered to the chassis base 22, a minute space (not shown) may be formed therebetween. Accordingly, the most amount of the heat generated in driving the plasma display panel 10 diffuses and radiates through the heat dissipating sheet 21.

The chassis base 22 including the heat dissipating sheets 21 on the front surface thereof is adhered to the rear substrate 12 of the plasma display panel 10 using, for example, a double sided tape 26 to support the plasma display panel 10. In addition, the chassis base 22 includes the printed circuit boards 23 and the partly rigid and partly flexible printed circuit boards 30 on the opposite side of the plasma display panel 11, that is to say, on the rear surface of the chassis base 22. Accordingly, the chassis base 22 has enough mechanical rigidity to support the plasma display panel 11 on the front surface thereof and to support the printed circuit boards 23 and the partly rigid and partly flexible printed circuit boards 30 on the rear surface thereof.

In general, the plasma display device may include a plurality of printed circuit boards in order to drive the plasma display panel.

The plasma display device according to some embodiment includes the plurality of partly rigid and partly flexible printed circuit boards 30. Although all the printed circuit boards may be formed as the partly rigid and partly flexible printed circuit boards 30 in order to control the plasma display panel, in one embodiment, a part of the printed circuit boards are formed as the partly rigid and partly flexible printed circuit boards 30.

For example, in one embodiment, an address buffer board 23a, an image processing/control board 23b, and a power board 23c are formed as the printed circuit boards 23. The sustain board 31 and the scan board 32 are formed as the partly rigid and partly flexible printed circuit boards 30. Accordingly, the partly rigid and partly flexible printed circuit boards 30, for example, the sustain board 31 and the scan board 32 are described.

Referring to FIGS. 1 and 2, one side of the sustain board 31 is connected to the terminals 41a of the sustain electrodes 41 to apply a driving voltage to the sustain electrodes 41. One side of the scan board 32 is connected to the terminals 42a of the scan electrodes 42 to apply driving voltages to the scan electrodes 42. In addition, the sustain board 31 and the scan board 32 may be mounted on different sides of the chassis base 22.

For convenience of description, the chassis base 22 is firstly described. The chassis base 22 has a rectangular plate shape including two facing long sides 22a and 22b and two facing short sides 22c and 22d perpendicular to the long sides 22a and 22b.

Accordingly, the long sides 11a and 11b of the front substrate 11 of the plasma display panel 10 correspond to the long sides 22a and 22b of the chassis base 22. The short sides 11c and 11d of the front substrate 11 correspond to the short sides 22c and 22d of the chassis base 22.

Referring to the embodiment of FIG. 1, the sustain board 31 is mounted on a short side 22c of the chassis base 22, and the scan board 32 is mounted on the other short side 22d of the chassis base 22. The sustain board 31 includes a rigid circuit 131 mounted on the chassis base 22 (refer to FIG. 1) and a flexible circuit 231 connect to the sustain electrodes 41 (refer to FIG. 3).

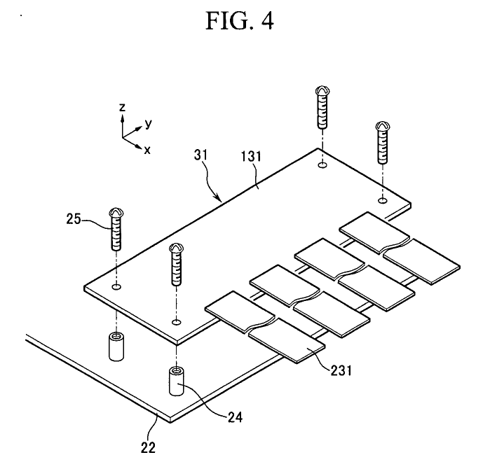

Referring to FIG. 4, the rigid circuit 131 of the sustain board 31 is disposed on bosses 24 on the chassis base 22 and fixed by set screws 25 to be engaged with the bosses 18. The flexible circuit 231 is connected to the rigid circuit 131 and to the sustain electrodes 41.

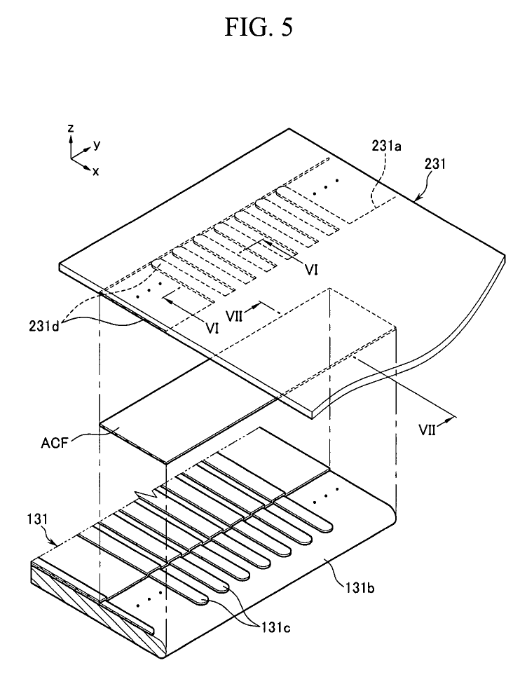

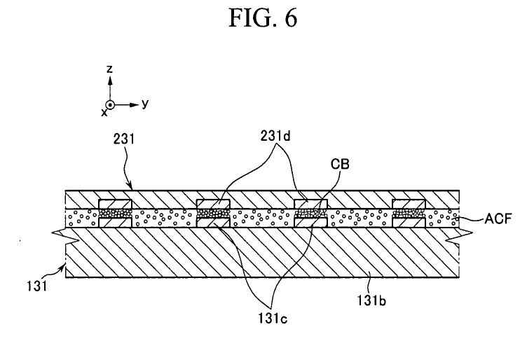

Referring to FIGS. 5 and 6, the rigid circuit 131 includes a substrate 131b on which a circuit pattern 131a is formed and rigid terminals 131c which are connected to the circuit pattern 131a are exposed at an end of the substrate 131b. Since the substrate 131b is disposed in parallel with the plasma display panel 10, the rigid terminals 131c are formed on an end of the plasma display panel 10 in the xy-plane direction.

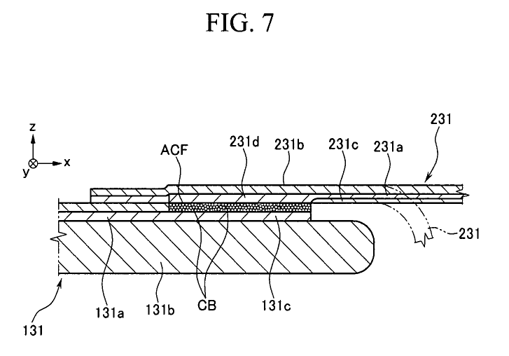

Referring to FIG. 7, the flexible circuit 231 includes two films 231b and 231c between which a first circuit pattern 231a is formed and flexible terminals 231d which are connected to the first circuit pattern 231a to be exposed to one film 231b. The flexible terminals 231d face the rigid terminals 131c.

In addition, in the plasma display panel 10, since the common voltage is applied to the sustain electrodes 41, the first circuit pattern 231a has a structure to be connected to the plurality of sustain electrodes 41. Specifically, the flexible circuit 231 includes the first circuit pattern 231a. The plurality of sustain electrodes 41 are connected to the first circuit pattern 231a. The rigid circuit 131 is connected to the plurality of flexible circuits 231 each of which includes the first circuit pattern 23 la (refer to FIGS. 1, 2, and 4).

The rigid circuit 131 and the flexible circuit 231 are connected to each other through the rigid terminals 131c and the flexible terminals 231d. The rigid terminals 131c and the flexible terminals 231d have a pitch P and face each other (refer to FIGS. 5 and 6). The rigid terminals 131c and the flexible terminals 231d are connected to each other by using conductive balls CBs which are, in some embodiments, densely disposed therebetween (refer to FIGS. 6 and 7). The conductive balls CBs which connect the facing rigid terminals 131c and the flexible terminals 231d with a fine pitch may be, for example, an anisotropic conductive film (ACF).

The rigid circuit 131 of the sustain board 31 is mounted on the rear surface of the chassis base 22 at the short side 22c. The flexible circuit 231 is connected to the sustain electrodes 41 of the plasma display panel 10. Accordingly, as shown in FIG. 3, the flexible circuit 231 maintains a bent state in the plasma display device. In addition, as shown in FIG. 7, bending force acts on the flexible circuit 231 toward the rigid circuit 131. The circuit pattern 231a of the flexible circuit 231 can be protected by preventing the interference between the bended flexible circuit 231 and the rigid circuit 131. Accordingly, an end of the rigid circuit 131 has a curved shape.

In the aforementioned partly rigid and partly flexible printed circuit board 30, that is to say, the sustain board 31 which is formed as one body by connecting the rigid circuit 131 to the flexible circuit 231, when the plasma display device is assembled, a connection operation between the rigid circuit 131 and the flexible circuit 231 is unnecessary and the number of components is reduced by removing connectors.

Since the sustain electrodes 41 and the rigid circuit 131 of the sustain board 31 are connected to each other as one body without an additional connection operation, the connection reliability between the sustain electrodes 41 and the rigid circuit 131 is improved, and the EMI noise is reduced by removing the connectors from which impurities are introduced and the EMI noise would otherwise be generated.

Referring to FIG. 3, first and second sealing members 27a and 27b are formed on the contact portions between the terminals 41a of the sustain electrode 41 and the flexible circuit 231. The space between the short side 11c of the front substrate 11 and one surface of the flexible circuit 231 near the short side 11c is filled with the first sealing member 27a. Accordingly, the first sealing member 27a prevents impurities and moisture from being introduced into the contact portion between the short side 11c and the surface of the flexible circuit 231. The space between a short side of the rear substrate 12 and the other surface of the flexible circuit 231 near the short side is filled with the second sealing member 27b. Accordingly, the second sealing member 27b prevents impurities and moisture from being introduced into the contact portion between the short side and the other surface of the flexible circuit 231. The first and second sealing members 27a and 27b may, for example, be made of silicone.

Referring to FIG. 1, again, the scan board 32 is mounted on the other side 22d of the chassis base 22. The scan board 32 includes a first rigid circuit 132 mounted on the chassis base 22 (refer to FIG. 1) and a first flexible circuits 232 connected to the scan electrodes 42 (refer to a connection structure of the sustain electrodes of FIG. 3). In addition, the scan board 32 further includes scan buffer boards 33. The scan buffer boards 33 are connected between the first flexible circuits 232 and the first rigid circuit 132.

Since the scan board 32 is mounted on the chassis base 22 in substantially the same structure as the sustain board 31, the description on the same structure is omitted, and the different structure from the sustain board 31 will be described. Specifically, the scan board 32 and the scan buffer board 33 are mounted on the chassis base 22 using the bosses 24 and the set screws 25 similarly to the sustain board 31.

Unlike the sustain electrodes 41, the scan electrodes 42 are selectively supplied with the driving voltages in order to select the discharge cell DC. Accordingly, the first flexible circuit 232 includes second circuit patterns 232a connected to the plurality of scan electrodes 42 (refer to FIG. 2). Flexible terminals 232d connected to the second circuit patterns 232a are separately formed and connected to the scan electrodes 42.

The scan buffer board 33 includes a second rigid circuit 133 and a second flexible circuit 233. The second rigid circuits 133 are mounted on the chassis base 22 between the first flexible circuits 232 and the first rigid circuit 132 and connected to the first flexible circuits 232. The second flexible circuits 233 are connected to the second rigid circuits 133 to be connected to the first rigid circuit 132. The scan electrodes 42 are connected to the first rigid circuit 132 through the first flexible circuits 232, the second rigid circuits 133, and the second flexible circuits 233.

The partly rigid and partly flexible printed circuit board 30 having a connection structure between the rigid circuit 131 and the flexible circuit 231, which is applied to the sustain board 31, can be similarly applied to the scan board 32 and the scan buffer board 33.

The rigid terminals 131c and the flexible terminals 231d of the sustain board 31, and the conductive balls CBs interposed therebetween may be similarly applied to the connection structure among the scan board 32, the first and second rigid circuits 132 and 133, and the first and second flexible circuit 232 and 233. Accordingly, detailed description will be omitted.

As described above, when the sustain board 31, the scan board 32, and the scan buffer board 33 are applied to the partly rigid and partly flexible printed circuit board 30, connection reliability among the sustain and scan electrodes 41 and 42 and the partly rigid and partly flexible printed circuit board 30 is improved, and the EMI noise is further reduced.

As described above, according to the plasma display device, the partly rigid and partly flexible printed circuit board is mounted on the chassis base and connected to the display electrodes of the plasma display panel, thereby improving the connection reliability between the display electrodes and the partly rigid and partly flexible printed circuit board and reducing EMI noise. In addition, the partly rigid and partly flexible printed circuit boards are connected to each other, thereby improving the connection reliability between the partly rigid and partly flexible printed circuit boards and further reducing the EMI noise. In addition, the partly rigid and partly flexible printed circuit board is applied, and the number of components is reduced, and cost is thus reduced.

While embodiments have been described in connection with what is presently considered to be practical, it is to be understood that the invention is not limited to the disclosed embodiments, but, on the contrary, is intended to cover various modifications and equivalent arrangements.

What is claimed is:

1. A plasma display device comprising:
a plasma display panel configured to display an image and having display electrodes;
a chassis base configured to support the plasma display panel; and
a partly rigid and partly flexible printed circuit board mounted on the chassis base on a side opposite the plasma display panel and connected to the display electrodes of the plasma display panel.

2. The plasma display device of claim 1, wherein the partly rigid and partly flexible printed circuit board comprises:
a rigid circuit mounted on the chassis base; and
a flexible circuit connected to the rigid circuit and to the display electrodes of the plasma display panel.

3. The plasma display device of claim 2,
wherein the rigid circuit includes rigid terminals formed on an end of the plasma display panel, and
wherein the flexible circuit includes flexible terminals facing the rigid terminals.

4. The plasma display device of claim 3, wherein the rigid circuit has a curved shape in order to prevent interference with the flexible circuit.

5. The plasma display device of claim 3, further comprising an anisotropic conductive film interposed between the rigid circuit and the flexible circuit to connect the rigid terminals and the flexible terminals.

6. The plasma display device of claim 3, wherein the rigid circuit includes:
a substrate on which a circuit pattern is formed; and
a plurality of rigid terminals connected to the circuit pattern and exposed at an end of the substrate,
and wherein the flexible circuit includes:
two films between which a circuit pattern is formed; and
a plurality of flexible terminals connected to the circuit pattern and exposed to one of the films, and
wherein the rigid terminals and the flexible terminals have a predetermined pitch, face each other, and are connected to each other with conductive balls disposed therebetween.

7. The plasma display device of claim 2, wherein a plurality of flexible circuits are connected to the rigid circuit.

8. The plasma display device of claim 7, wherein the display electrodes include sustain electrodes and scan electrodes, and wherein the flexible circuit comprises a first circuit pattern connected to the sustain electrodes.

9. The plasma display device of claim 7,
wherein the display electrodes comprise the sustain electrodes and the scan electrodes, and
wherein the flexible circuit comprises second circuit patterns connected to the scan electrodes.

10. The plasma display device of claim 1,
wherein the display electrodes comprise sustain electrodes and scan electrodes,
wherein the chassis base has a substantially rectangular shape with two facing long sides and two facing short sides substantially perpendicular to the long sides, and
wherein the partly rigid and partly flexible printed circuit board comprises:
a sustain board comprising a rigid circuit and mounted on a short side of the chassis base and connected to the sustain electrodes using flexible circuits; and
a scan board comprising another rigid circuit and mounted on the other short side of the chassis base and connected to the scan electrodes using additional flexible circuits.

11. The plasma display device of claim 10, wherein the scan board further comprises a scan buffer board connected between the additional flexible circuits and the rigid circuit of the scan board.

12. The plasma display device of claim 11, wherein the scan buffer board comprises:
another rigid circuit mounted on the chassis base between the additional flexible circuits and the rigid circuit of the scan board and connected to the additional flexible circuits; and
another flexible circuit through which the rigid circuit of the scan buffer board is connected to the rigid circuit of the scan board.

13. A plasma display device comprising:
a plasma display panel configured to display an image;
a chassis base configured to support the plasma display panel; and
a printed circuit board mounted on the chassis base and connected to display electrodes of the plasma display panel with a flexible circuit.

14. The device of claim 13, wherein the printed circuit board is rigid.

15. The device of claim 13, wherein the printed circuit board comprises rigid terminals and the flexible circuit comprises flexible terminals.

16. The device of claim 13, wherein the flexible circuit is bent.

17. The device of claim 13, wherein the display electrodes comprise sustain electrodes and scan electrodes.

18. The device of claim 13, wherein the flexible circuit comprises a circuit pattern connected to the display electrodes.

19. The device of claim 18, wherein the display electrodes comprise sustain electrodes.

20. The device of claim 18, wherein the display electrodes comprise scan electrodes.
